(19) United States
(12) Patent Application Publication
(10) Pub. No.: US 2016/0209141 A1
(43) Pub. Date: Jul. 21, 2016

(54) FIREARM SAFETY ARRANGEMENT

(71) Applicant: MIKLATECH OY, Oulu (FI)

(72) Inventors: Jan LAMPELA, Oulu (FI); Jari NURRO, Oulu (FI)

(73) Assignee: MIKLATECH OY, Oulu (FI)

(21) Appl. No.: 15/024,640

(22) PCT Filed: Jul. 4, 2014
(86) PCT No.: PCT/FI2014/050554

§ 371 Date: Mar. 24, 2016

(30) Foreign Application Priority Data
Sep. 24, 2013 (FI) 20135955

(51) Int. Cl. F41A 17/06; G01D 5/26; F41A 17/46

(52) U.S. Cl. CPC F41A 17/06; F41A 17/46; F41A 17/063; G01D 5/26

(57) ABSTRACT

A firearm safety device includes one or more optical sensors fastenable to a trigger guard of a firearm and configured to detect a user's finger inside the trigger guard when the sensors are attached to the trigger guard and a detector to detect the position of the safety catch of the firearm. The device further includes an apparatus connected to the one or more optical sensors and the detector and activated when the sensors detect no finger inside the trigger guard and the detector detects the safety catch is off.

### FIELD

The exemplary and non-limiting embodiments of the invention relate generally to firearm safety arrangements and especially to a firearm safety device preventing accidental firing of a firearm.

### BACKGROUND

Firearms traditionally comprise a safety catch mechanism which prevents the firing of the arm when set into on position. The user of the firearm must manually set the safety catch in off position if the firearm is to be fired. However, several accidents have happened when the user of the firearm has unintentionally forgotten the safety catch to off position and handled the firearm in a careless manner. The user may accidentally fire the firearm if the safety catch is in the off position without the user's knowledge.

To improve the safety of firearms various solutions have been proposed. For example, solutions which employ pressure sensors have been suggested. One drawback common to all suggestions is that they cannot be applied to existing firearms but require factory assembly Thus, there is a need for a safety arrangement which can be installed to firearms existing on the market.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided a firearm safety device, comprising: one or more optical sensors configured to detect a user's finger inside the trigger guard; a detector to detect the position of the safety catch of the firearm; an apparatus connected to the one or more optical sensors and the detector and activated when the sensors detect no finger inside the trigger guard and the detector detects the safety catch is off.

In an embodiment, the one or more optical sensors are fastenable to a trigger guard of a firearm and configured to detect a user's finger inside the trigger guard when the sensors are attached to the trigger guard. In an embodiment, the one or more optical sensors are located in the body of the firearm.

Embodiments of the invention provide several advantages. The proposed safety arrangement can be installed to virtually any firearm currently used in the field. The arrangement does not require any special assembly. The proposed arrangement may also be preinstalled at a firearm factory.

### LIST OF DRAWINGS

Embodiments of the present invention are described below, by way of example only, with reference to the accompanying drawings, in which

FIGS. 1A, 1 B and 1C illustrate examples of embodiments;

FIG. 2 illustrates an example of fastening of a housing to the trigger guard of a firearm;

FIGS. 3A and 3B illustrate an example of an embodiment;

FIG. 4 illustrates an embodiment comprising a server; and

FIG. 5 illustrates a simplified example of a device in which some embodiments of the invention may be applied.

### DESCRIPTION OF SOME EMBODIMENTS

In an embodiment, optical sensors are attached to the trigger guard of a firearm and a detector near the safety catch of the firearm. The optical sensors are configured to detect whether a finger of the user is inside the trigger guard. The detector is configured to detect the position of the safety catch. If the finger not inside the trigger guard and the safety catch is off, an alarm is sounded and/or the firing of the firearm is mechanically prevented. The safety catch may be mechanically put in on position or the movement of the trigger is mechanically prevented.

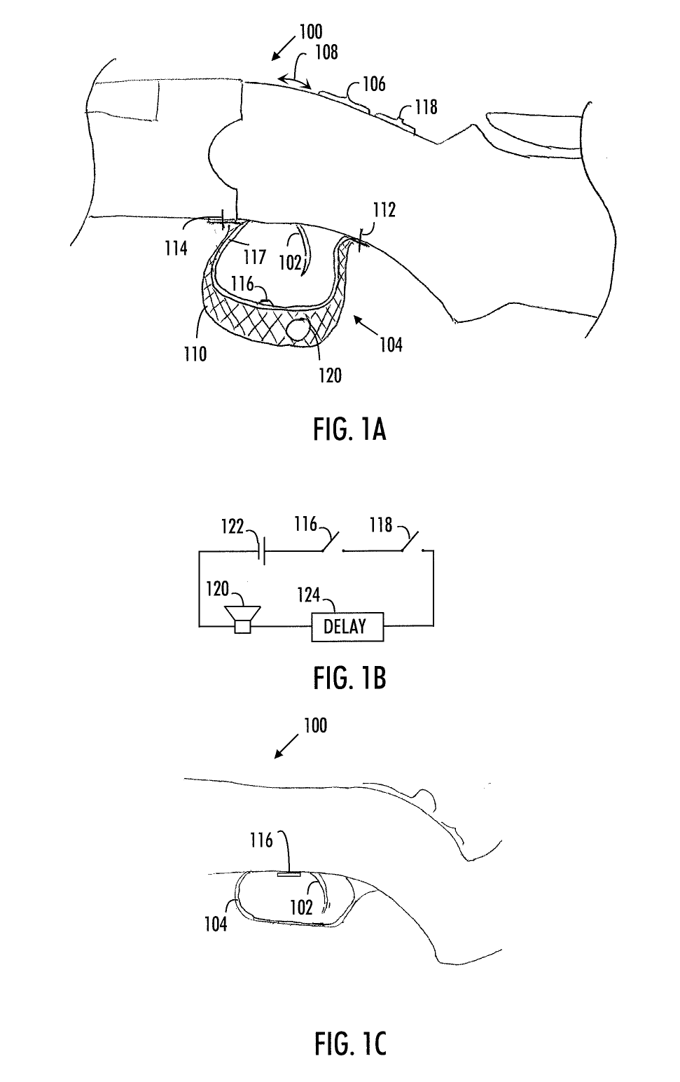

FIG. 1A illustrates an example of a firearm safety device of an embodiment. The figure shows a middle part of a firearm 100. The firearm may comprise a stock and a barrel but they are not shown in full.

The firearm comprises a trigger 102 and a trigger guard 104. In addition, the firearm comprises a conventional safety catch 106. The safety catch has an on-position, in which the firearm cannot be fired by pressing the trigger. The safety catch has an off-position, when the firing of the firearm is possible by pressing the trigger. Typically the safety catch is movable in horizontal direction as illustrated by the arrow 108. In some designs, the safety catch may move in vertical direction or radially from either end of the safety catch. The location of the safety catch in FIG. 1 is merely an example. The location of the safety catch varies between different firearms and it is not relevant regarding the embodiments of the invention.

In an embodiment, the firearm safety device comprises a housing 110, which is fastenable to the trigger guard of the firearm. The housing may comprise a layer of elastic material 117 which presses against the trigger guard 104 and which hardens after the housing has been attached to the trigger guard. In an embodiment, the use of elastic material ensures that the housing fastens to the trigger guard tightly regardless of the shape of the trigger guard. This enables the use of the same housing with different types of trigger guards and firearms.

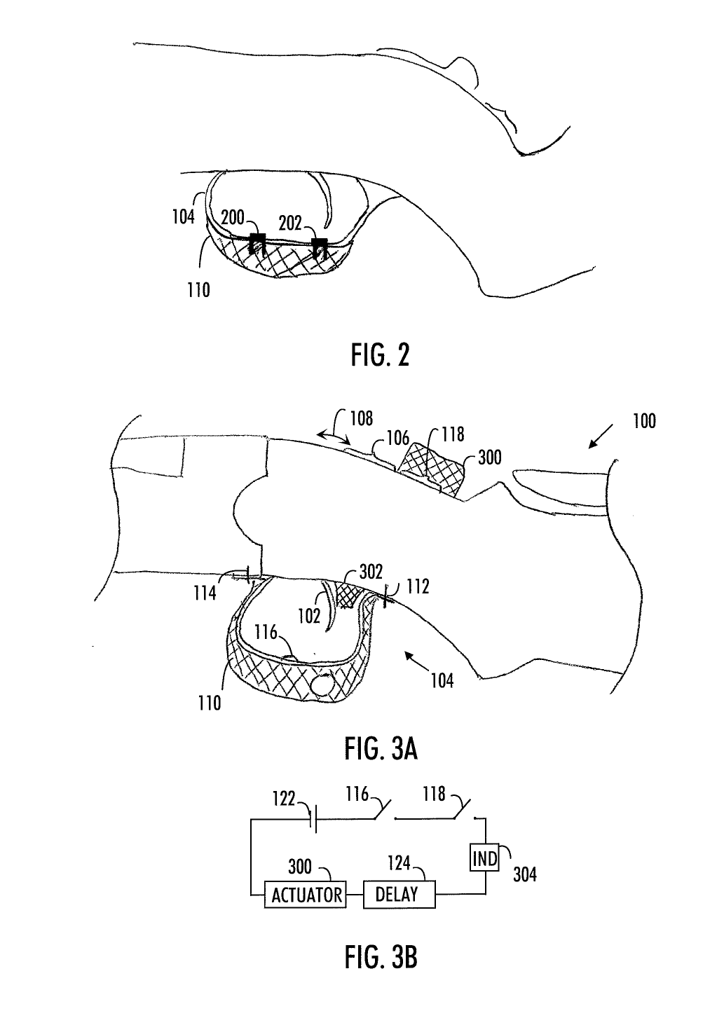

The housing may be fastened to a trigger guard in various ways. In an embodiment, the housing may be fastened to the trigger guard by using screws or other fasteners 112, 114. FIG. 2 illustrates another example of possible fastening. The housing 110 may be fastened to the trigger guard 104 of a firearm 100 with fasteners 200, 202. The fasteners and the elastic material enable the fastening of the housing to any kind of firearm having a trigger guard.

A simple example of possible fastening is to utilize cable ties to fasten the housing to the trigger guard. The fasteners 200, 202 may be realized with hand turned screws, glue (which may be part of the elastic material), adhesive tape or other adhesive material, volcanic tape, clips or locking hooks.

In an embodiment, the housing may be selected on the basis of the firearm model. Thus, the housing may be designed for each firearm model separately.

Referring back to FIG. 1A, the firearm safety device of an embodiment comprises one or more optical sensors 116 configured to detect whether a finger of the user is inside the trigger guard 104. The optical sensor or sensors enable the detection to be performed without any disturbance to the user of the firearm. The detection is performed without the user even noticing the procedure. There are no special operations the user has to perform such as keeping the firearm in a certain position in a special way. Thus, the handling of the firearm and firing operations are not affected by the solution according to the invention.

In the example embodiment of FIG. 1A, the firearm safety device further comprises a detector 118 configured to detect the position of the safety catch 106. The detector may be realized in various ways. For example, the detector may comprise an element attached to the safety catch and an element attached to the body of the firearm, and the displacement of the safety catch element may indicate the position of the safety catch.

The detection may be performed magnetically, for example. A detector may detect a change in a magnetic field when safety catch is moved in different positions. The detector may use a laser signal, optical sensors, a photocell, an ultrasound sensor, a mechanical sensor, an acceleration sensor or other kind of sensor when determining the position of the safety catch.

In the example embodiment of FIG. 1A, the firearm safety device further comprises an apparatus 120 connected to the one or more optical sensors 116 and the detector 118 and activated when the sensors detect no finger inside the trigger guard and the detector detects the safety catch is off. In an embodiment, the apparatus 120 is a speaker configured to produce a sound. In an embodiment, the apparatus 120 is a light source configured to produce light. The light source may be a led, for example. The apparatus may also produce a vibration. In an embodiment, the apparatus may transmit an alarm to user equipment.

The detector 118 and the optical sensors may be connected to the apparatus 120 either with a wired connection or with a wireless connection.

FIG. 1C illustrates an example of a firearm safety device of an embodiment. The figure shows a middle part of a firearm 100. The firearm may comprise a stock and a barrel but they are not shown in full. This example embodiment is otherwise similar to the example of FIG. 1A, but the location of the sensors. In this example the sensors 116 are located in the body of a firearm. The sensors may be located in the body of the firearm above the trigger guard, for example. The sensors may have been installed in the firearm directly at the factory, for example.

FIG. 1B illustrates an example of electrical connections of an embodiment of the firearm safety device. The firearm safety device may comprise a power source 122 which may be a battery or a rechargeable battery. The device further may comprise the optical sensor or sensors 116, the detector 118 and a speaker 120 connected in series. The optical sensor 116 and the detector 118 may be configured to pass current through to the speaker 120 if a user's finger is not inside the trigger guard and the safety catch is in off position. If both of these connections are met, the safety device is configured to produce an alarm with the speaker 120. This way the user of the firearm is reminded to turn the safety catch in on position and accidental firing of the firearm can be prevented.

In an embodiment, the safety device comprises a delay element 124, which delays the producing of the alarm for a predetermined time. The duration of the delay may be few seconds, for example. The delay element may delay the alarm so that the user may switch the safety catch off and place a finger on the trigger without too much haste. Correspondingly the user may take a finger off the trigger and place the safety catch in on position within the delay.

In an embodiment, the battery 122, the optical sensor or sensors 116, and the speaker 120 are located in the housing 110. The delay element 124 may as well be located in the housing. In an embodiment, the housing may be fastenable to other parts of the firearm than the trigger guard. The housing may be located in the stock of the firearm, for example. The optical sensors may be fastened to the trigger guard but the housing may comprise an power source, a speaker and a connection to the optical sensors and the detector.

FIG. 3A illustrates another example of a firearm safety device of an embodiment. The figure shows a middle part of a firearm 100. The firearm may comprise a stock and a barrel but they are not shown in full.

The housing 110, the one or more optical sensors 116, the detector 118 and the fastening of the housing may be realized as described above. In this embodiment, the firearm safety device comprises an apparatus 300 configured to prevent the firing of the firearm mechanically. The apparatus 300 is configured to mechanically place the safety catch 106 of the firearm in on position if a user's finger is not inside the trigger guard and the safety catch is in off position. The mechanical realization of the apparatus depends on the physical realization of the safety catch 106. The apparatus 300 may operate on electricity or gas or it may be pneumatic, or utilise a spring to power the movement of the safety catch to on position.

FIG. 3B illustrates an example of electrical connections of an embodiment of the firearm safety device. The firearm safety device may comprise a power source 122 which may be a battery or a rechargeable battery. The device further may comprise the optical sensor or sensors 116, the detector 118 and the apparatus 300 connected in series. The optical sensor 116 and the detector 118 may be configured to pass current through to the apparatus 300 if a user's finger is not inside the trigger guard and the safety catch is in off position. If both of these connections are met, the safety device is configured to mechanically place the safety catch 106 of the firearm in on position. This way accidental firing of the firearm can be prevented.

In an embodiment, the safety device comprises a delay element 124, which delays the producing of the alarm for a predetermined time. The duration of the delay may be few seconds, for example.

FIG. 3A also illustrates another example where the firearm safety device comprises a trigger controller 302 configured to mechanically prevent the movement of the trigger when the sensors detect no finger inside the trigger guard and the detector detects the safety catch is off. The trigger controller may in off position locate against the body of the firearm and turn to on position if sensor and detector so indicate.

In an embodiment, the movement of the trigger may be prevent magnetically or other means.

FIG. 3B also illustrates an embodiment where the firearm safety device comprises a sensor or indicator 304 indicating the position of the safety catch. The sensor or indicator 304 is detectable by an external sensor in a wireless manner. The sensor or indicator may communicate with an external sensor network and transmit information on the position of the safety catch.

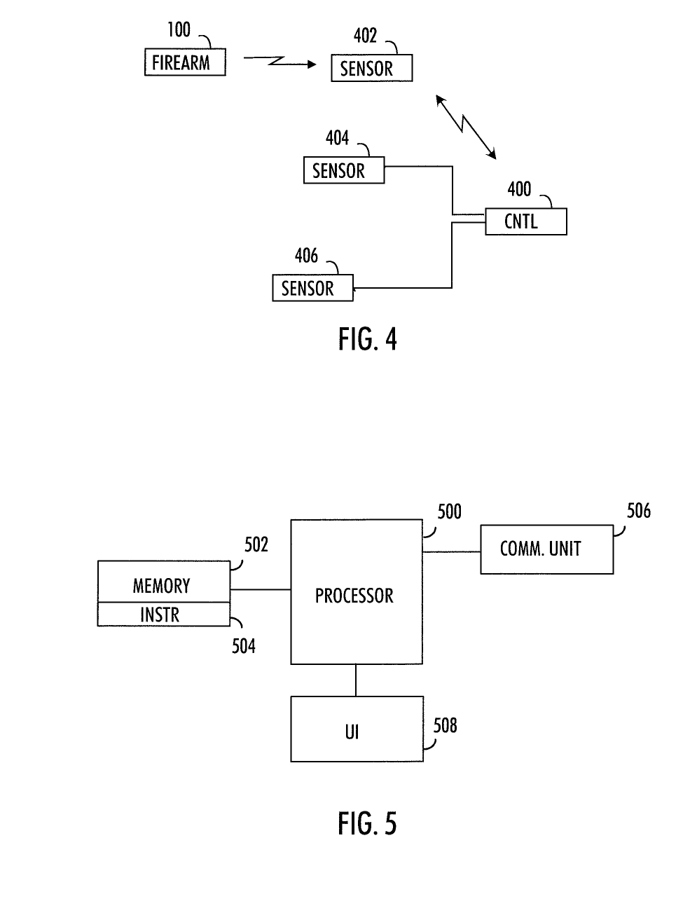

FIG. 4 illustrates an embodiment comprising a server or controller 400 of a local area network or sensor network comprising a set of sensors 402, 404, 406. The number of sensors is not limited to this example. The sensors may be connected to the server or controller 400 in a wired or wireless manner. The connection may be a wireless local area network such as Wi-Fi or WLAN (Wireless Local Area Network) based on IEEE (Institute of Electrical and Electronics Engineers) 802.11 standard or its evolution versions, WSN (Wireless Sensor Network) or WiMAX (Worldwide Interoperability for Microwave Access, for example. Also other realizations are possible as one skilled in the art is well aware.

In this embodiment, a firearm 100 is brought into the service area of the server or controller 400. The indicator 304 of the firearm may indicate that the safety catch of the firearm is in off position. A sensor 402 of the network controlled by the server 400 may detect the indicator and transmit information on the detection to the server 400. The server may receive from the sensor information that a firearm having safety catch in off position is in the serving area of the wireless network and initiate an alarm signal on the basis of the detection. The alarm signal may be a sound of light or some other type of alarm. For example, the server may transmit a message to a predetermined user equipment, mobile phone,r tablet computer or other suitable household device such as a television, for example.

The sensors are small typically battery powered devices which may comprise a controller, memory, a wireless transceiver and sensing apparatuses which in general may detect magnetic fields, temperature, light, for example. Each sensor may have a unique internet address.

FIG. 5 illustrates an embodiment. The figure illustrates a simplified example of a device in which embodiments of the invention may be applied. In some embodiments, the device may be a server 400 of FIG. 4 maintaining a wireless or wired local area network. In some embodiments, the device may be a part of a server or a respective device. In general, device may be a computing device including, but not limited to, the following types of devices: a personal computer, a server computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 500 configured to control at least part of the operation of the device.

The device may comprise a memory or an interface 502 to a memory for storing data. Furthermore the memory may store software 504 executable by the control circuitry 500. The memory may be integrated in the control circuitry.

The device may comprise a communication interface 506. The communication interface is operationally connected to the control circuitry 500. The interface may provide the device a connection to a local area network comprising sensors and optionally to a communication system. The connection may be wired or wireless. The interface may be a network interface card, a transceiver or any other kind of apparatus providing network connections.

The software 504 may comprise a computer program comprising program code means adapted to cause the control circuitry 500 of the device to control the communication interface 506.

The device may further comprise user interface 508 operationally connected to the control circuitry 500. The user interface may comprise a display which may be touch sensitive, a keyboard or keypad (which may be implemented using a touch sensitive display), a microphone and a speaker, for example.

The control circuitry 500 is configured to execute one or more applications. The applications may be stored in the memory 502.

The applications may control the control circuitry 610 to receive from a wireless network information that a firearm having safety catch in off position is in the serving area of the wireless network; initiate an alarm signal on the basis of the detection.

Some of the above mentioned units might be accessories connectable to a device.

It will be obvious to a person skilled in the art that, as technology advances, the inventive concept can be implemented in various ways. The invention and its embodiments are not limited to the examples described above but may vary within the scope of the claim.

1-16. (canceled)

17. A firearm safety device, comprising:
one or more optical sensors configured to detect a user's finger inside the trigger guard;
a detector to detect the position of the manually operable safety catch of the firearm;
an apparatus connected to the one or more optical sensors and the detector and activated when the sensors detect no finger inside the trigger guard and the detector detects the safety catch is off.

18. The firearm safety device of claim 17, wherein the one or more optical sensors are located in the body of the firearm.

19. The firearm safety device of claim 17, wherein the one or more optical sensors are fastenable to a trigger guard of a firearm and configured to detect a user's finger inside the trigger guard when the sensors are attached to the trigger guard.

20. The firearm safety device of claim 17, wherein the apparatus comprises a speaker configured to produce sound when the sensors detect no finger inside the trigger guard and the detector detects the safety catch is off.

21. The firearm safety device of claim 17, wherein the apparatus comprises light source configured to produce light when the sensors detect no finger inside the trigger guard and the detector detects the safety catch is off.

22. The firearm safety device of claim 17, wherein the apparatus comprises a safety catch controller configured to mechanically set the catch on when the sensors detect no finger inside the trigger guard and the detector detects the safety catch is off.

23. The firearm safety device of claim 17, wherein the apparatus comprises a trigger controller configured to mechanically prevent the movement of the trigger when the sensors detect no finger inside the trigger guard and the detector detects the safety catch is off.

24. The firearm safety device of claim 17, further comprising a delay element activating the apparatus after a given delay when the sensors detect no finger inside the trigger guard and the detector detects the safety catch is off.

25. The firearm safety device of claim 17, wherein the detector is wirelessly connected to the apparatus.

26. The firearm safety device of claim 19, comprising a housing fastenable to the trigger guard of a firearm, the housing comprising one or more optical sensors and an energy source.

27. The firearm safety device of claim 26, wherein the surface of the housing pressing against the trigger guard when the housing is attached to the trigger guard comprises elastic material which hardens after the housing has been attached to the trigger guard.

28. The firearm safety device of claim 19, comprising a housing fastenable to the firearm, the housing comprising an power source and a connection to the optical sensors and the detector.

29. The firearm safety device of claim 17, comprising an indicator indicating the position of the safety catch, the indicator being detectable by an external sensor in a wireless manner.

30. The firearm safety device of claim 18, wherein the one or more optical sensors in the body of a firearm are located above the trigger guard of the firearm.

31. An apparatus, comprising:
at least one processor; and
at least one memory including computer program code,
the at least one memory and the computer program code configured to, with the at least one processor, cause the apparatus at least to perform:
receive from a wireless network information that a firearm having a manually operable safety catch in off position is in the serving area of the wireless network;
initiate an alarm signal on the basis of the detection.

32. The apparatus of claim 31, wherein the apparatus is configured to transmit a message to predetermined user equipment on the basis of the detection.
